(19) United States
(12) Patent Application Publication
(10) Pub. No.: US 2016/0100594 A1
(43) Pub. Date: Apr. 14, 2016

(54) SMOKER AND GRILL

(71) Applicant: Matthew Barber, Lakeland, FL (US)

(72) Inventor: Matthew Barber, Lakeland, FL (US)

(21) Appl. No.: 14/878,928

(22) Filed: Oct. 8, 2015

Related U.S. Application Data
(60) Provisional application No. 62/061,663, filed on Oct. 8, 2014.

(51) Int. Cl. A23B 4/052

(52) U.S. Cl. CPC A23B 4/0523

(57) ABSTRACT

Some implementations can include a smoker having a cabinet housing a cooking chamber and a fire chamber. The smoker can include one or more inner sidewalls disposed within a cooking chamber, the inner sidewalls being spaced a distance from outer sidewalls so as to define a transfer space inside the cabinet, a fire chamber can have one or more openings into the transfer space, the inner sidewalls can have one or more openings formed at vertical intervals from a top of the cooking chamber to a bottom of the cooking chamber, the one or more openings can be configured to distribute heated air from the fire chamber to the cooking chamber via the transfer space.

### RELATED APPLICATIONS

This application claims the benefit of U.S. Provisional Application No. 62/061,663, entitled “Smoker and Grill Apparatus and System”, filed on Oct. 8, 2014, which is incorporated herein by reference in its entirety.

### TECHNICAL FIELD

Some implementations relate generally to food cooking equipment, and more particularly, to an apparatus and system for smoking or grilling food.

### SUMMARY

Some implementations can include a smoker having a cabinet housing a cooking chamber and a fire chamber. The cooking chamber can be defined by a cooking chamber top, a first portion of one or more outer sidewalls, a cooking chamber floor, and a first door. The fire chamber can be defined by a fire chamber top, a second portion of the one or more outer sidewalls, a fire chamber bottom and a second door. Some implementations of the smoker can also include an air inlet coupled to the fire chamber and configured to receive air from a source external to the cabinet and to convey the received air to the fire chamber.

The smoker can include one or more inner sidewalls disposed within the cooking chamber, the inner sidewalls being spaced a distance from the outer sidewalls so as to define a transfer space inside the cabinet, the fire chamber having one or more openings into the transfer space, the inner sidewalls having one or more openings formed at vertical intervals from a top of the cooking chamber to a bottom of the cooking chamber, the one or more openings configured to distribute heated air from the fire chamber to the cooking chamber via the transfer space. The smoker can further include a chimney having a first opening in a lower area the cooking chamber and a second opening to the exterior of the cabinet, the chimney configured to exhaust air from the cooking chamber of the smoker.

In some implementations, the cooking chamber top can include an opening having a hinged door, the opening being configured to receive a cooking pan (e.g., standard size catering pan) when the door is in an open position. The cooking chamber top opening having a hinged can be configured to receive a heat source when the door is in an open position.

The inner sidewalls can include rails configured to permit food cooking trays to be inserted into the smoker. In some implementations, the rails can have an “L” shape in cross section. In other implementations, the rails can have a “C” shape in cross section.

The inner sidewalls can include one or more top openings formed near the top of the cooking chamber, the one or more top openings can be configured to distribute heated air from the fire chamber to the cooking chamber via the transfer space. A portion of the one or more openings in the inner sidewalls near the top of the cooking chamber can be smaller relative to a portion of the one or more openings in the inner sidewalls near the bottom of the cooking chamber.

In some implementations the one or more openings in the inner sidewalls can be generally circular. In other implementations, the one or more openings in the inner sidewalls can be generally linear. In still other implementations, the one or more openings include a plurality of openings, and the plurality of openings can have one or more generally circular openings and one or more generally linear openings.

The smoker can include one or more temperature gauges configured to measure the temperature of the cooking chamber and/or the fire chamber. In some implementations, the smoker can include a first temperature gauge and a second temperature gauge, the first temperature gauge being disposed in an upper portion of the first, the second temperature gauge being disposed in a lower portion of the first door. The chimney can include a tube.

In some implementations, the one or more openings are spaced at uneven vertical intervals. The smoker can further comprise a pellet fuel system coupled to the fire chamber and configured to provide pellet fuel to the fire chamber.

The one or more openings can be in groups spaced at vertical intervals corresponding to sets of rails disposed on an inside surface of the inner sidewalls, each set of rails being configured to receive a cooking pan. The smoker can include a plurality of sets of rails disposed on an inside surface of the inner sidewalls, each set of rails being configured to receive a cooking pan.

### BRIEF DESCRIPTION OF THE DRAWINGS

FIG. 1 is a diagram showing a front perspective view of an example smoker in accordance with at least one embodiment.

FIG. 2 is a diagram showing a cut away front perspective view of an example smoker in accordance with at least one embodiment.

FIG. 3 is a diagram showing a rear perspective view of an example smoker in accordance with at least one embodiment.

FIGS. 4A-4C is a diagram showing an example smoker configuration in accordance with at least one embodiment.

FIGS. 5A-5C is a diagram showing an example smoker configuration in accordance with at least one embodiment.

FIG. 6 shows a front of an example smoker in accordance with at least one embodiment.

FIG. 7 shows a front of an example smoker in accordance with at least one embodiment.

FIG. 8 shows a front of an example smoker in accordance with at least one embodiment.

FIG. 9 is a top view of an example smoker in accordance with at least one embodiment.

FIG. 10 is a top view of an example smoker in accordance with at least one embodiment.

FIG. 11 is a front view of an example smoker in accordance with at least one embodiment.

### DETAILED DESCRIPTION

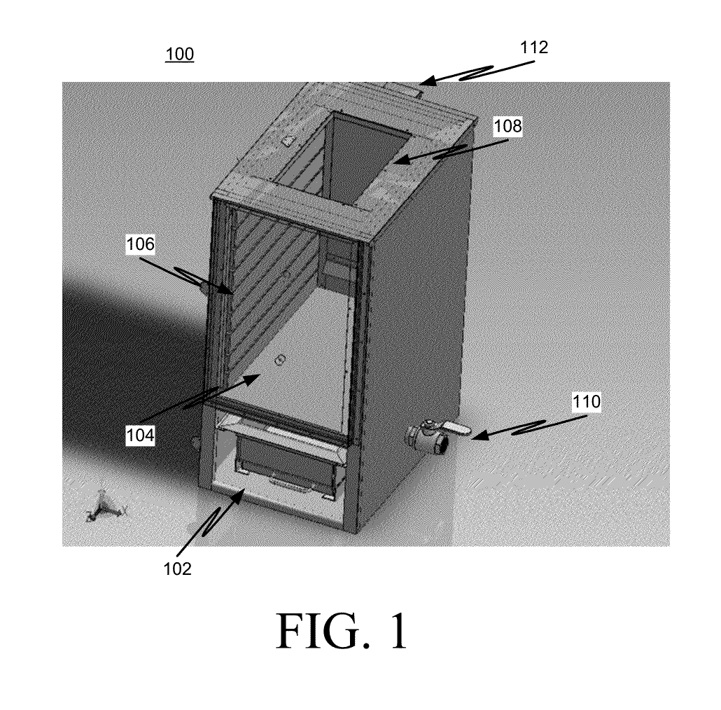

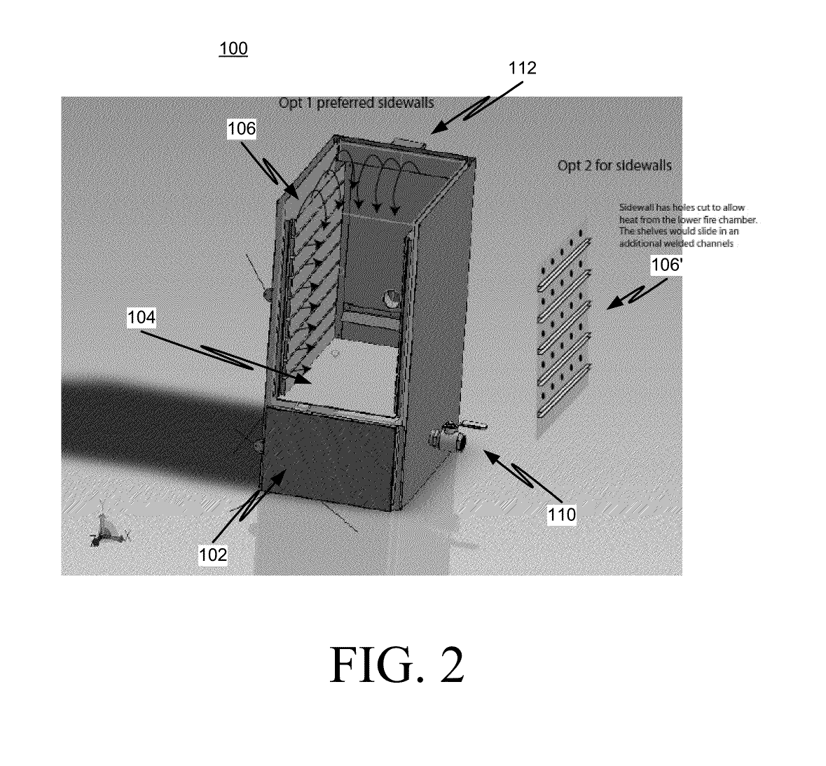

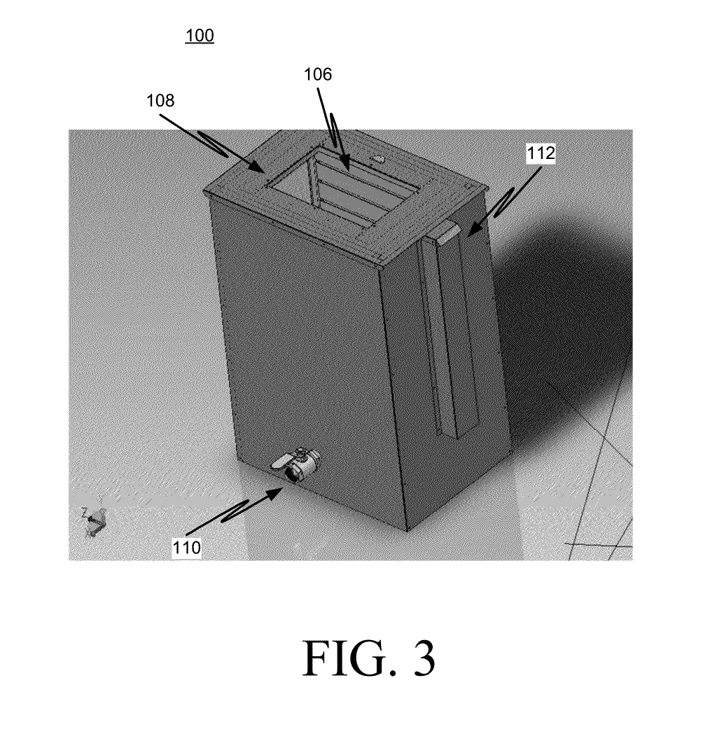

FIGS. 1-3 show diagrams of an example smoker in accordance with some implementations. A smoker cabinet 100 includes a firebox/fire chamber 102, a smokebox/cooking chamber 104 having a slotted sidewall(s) 106 (or sidewall(s) with circular perforations 106′), a top opening 108, an air inlet 110 and a chimney 112. It will be appreciated that the sidewalls 106 can include openings formed in shapes other than slots or circular holes, or could include a combination of slots, circular holes and/or other openings. The cooking chamber is defined by a cooking chamber top, a first portion of one or more outer sidewalls, a cooking chamber floor, and a first door. The fire chamber is defined by a fire chamber top, a second portion of the one or more outer sidewalls, a fire chamber bottom and a second door.

In operation, air enters the air inlet 110 (under natural flow or via a fan-driven forced air supply) and a heat source in the firebox 102 (e.g., charcoal, wood, pellets, gas, electric or a combination of these) produces heat and/or smoke that rises through a transfer space (e.g., a 1.5 inch gap) formed between the outer sidewall of the smoker cabinet and the inner sidewalls 106 and enters the smokebox via one or more slots in the sidewalls 106 (or holes in the sidewalls 106′) and flows in over the top of the inner sidewalls and/or back wall. The heat and/or smoke travels down and through/over meat or other food on cooking racks, pans or trays inserted in the sidewall slots and or placed on rails provided on the inner sidewalls 106 and exits the smoker via the chimney 112.

In some implementations, there is a 1.5 inch opening between the two sidewalls of the smoker (e.g., the outer sidewalls and inner sidewalls). The space between the sidewalls is open to the bottom fire chamber. The inner side walls have a series of slats (or holes or other openings) to permit heat and smoke from the fire chamber below to enter the cook chamber at multiple levels, which can help to ensure an even cooking temperature from top to bottom. The openings in the sidewalls can be spaced evenly or unevenly. In some implementations, the openings may be larger near the bottom of the cooking chamber and smaller near the top of the cooking chamber to help provide an even temperature throughout the smoker 100. The opening for the smoke stack can be located near the bottom rear of the cook chamber to create a natural convection flow.

Water pans can be inserted in the bottom grooves on the side walls to create humidity to aid in smoke ring creation and to aid in creating an even cooking temperature from top to bottom of the cooking chamber. Some implementations can include a door on the top of the smoker that opens up to the cooking chamber. This opening is sized for a full size standard catering pan. This can be used as a way to heat up side dishes by placing a pan containing the side dish into the opening. A heat source can be placed in the top opening (e.g., hot coals in a pan) so that the food in the top pan in the smoker gets heated in a manner similar to broiling food in an oven.

In another operating configuration, charcoal can be placed in a in a pan in the cooking chamber and the top door can be opened to permit the smoker to operate as a grill (e.g., for burger or steaks) using direct heat from the charcoal in the pan inside the cooking chamber.

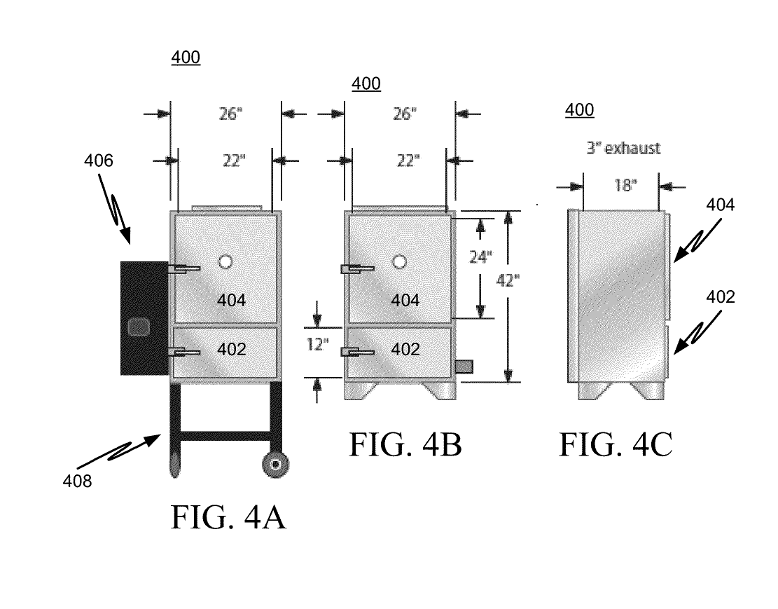

Example specifications for a smaller smoker embodiment (e.g., as shown in FIGS. 4A-4C) include: 6 shelf spaces, 3 shelf grates 18″×22″, 22″ w×18″ d×24″ h cooking chamber, and overall 26″ w×24″ d×46″ h. Some features include 1-3″ door temperature gauge, a slide out firebox, slide out ash pan, a warming pan door, a 1.5″ ball valve, a water pan, slam latches, stainless exterior, “evenflow” sidewalls (e.g., sidewalls with slots or holes as described herein). System can operate as a “low n slow” smoker or a grill when warming door is open and heat source placed in cooking chamber. The smoker can be configured with an optional pellet fuel system 406.

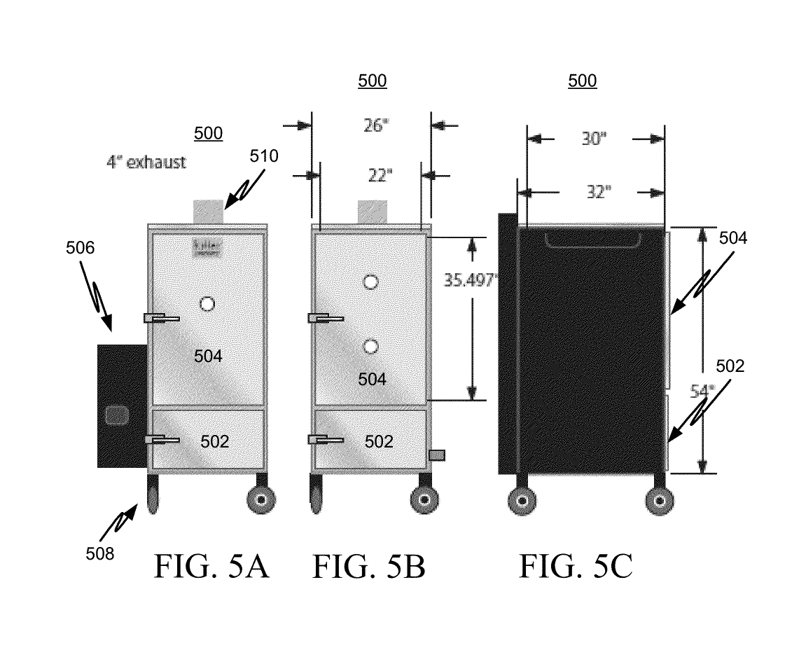

Example cooking capacity for a larger smoker embodiment (e.g., FIGS. 5A-5C) include: capability of cooking a minimum of 4 butts per shelf×4 shelves or 3 briskets per shelf×4 shelves or 14 “St. Louis”-style ribs per shelf×4 shelves. Example specifications for the larger smoker include: 9 shelf spaces, 4 shelf grates 22×30 (can use shelves or cook on hotel pans that fit in shelf grooves), 22″ w×30″ d×34″ h cooking chamber, and overall 26″ w×36″ d×60″ h. The larger smoker can also include 2-3″ door temperature gauges, configured to use hotel pans for water pans, a slide out firebox, a slide out ash pan, a warming pan door, a 1.5″ ball valve, slam latches, stainless exterior, and “evenflow” sidewalls (e.g., side walls with slots, holes or other openings as described herein). The system can be operated as a “low n slow” smoker or grill when warming door is open and heat source is placed in cooking chamber. The smoker can be configured with an optional pellet fuel system for use as heat source.

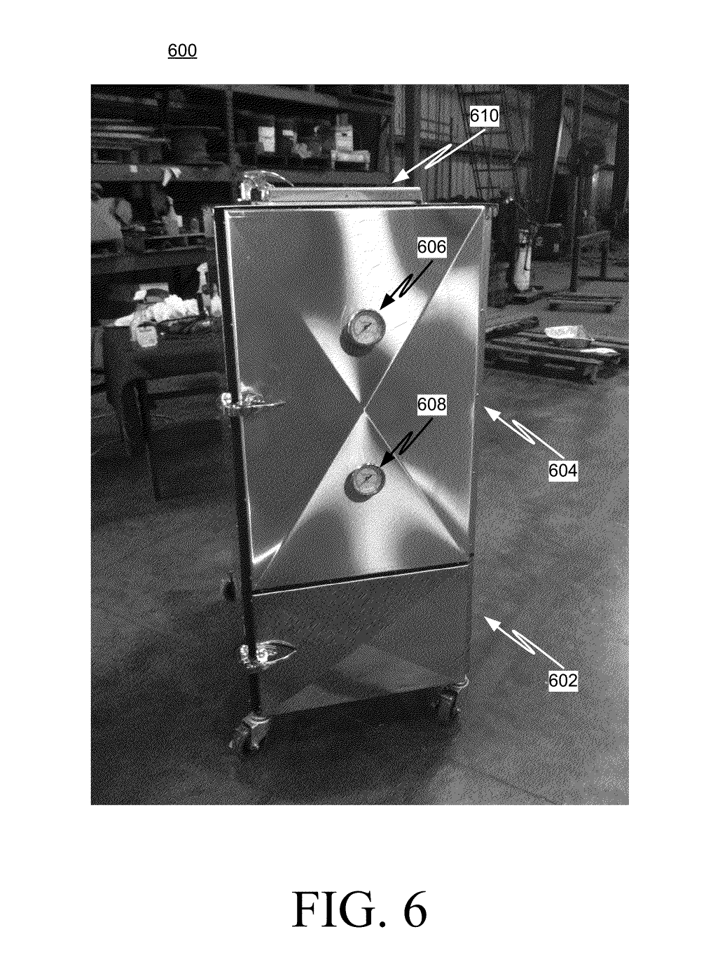

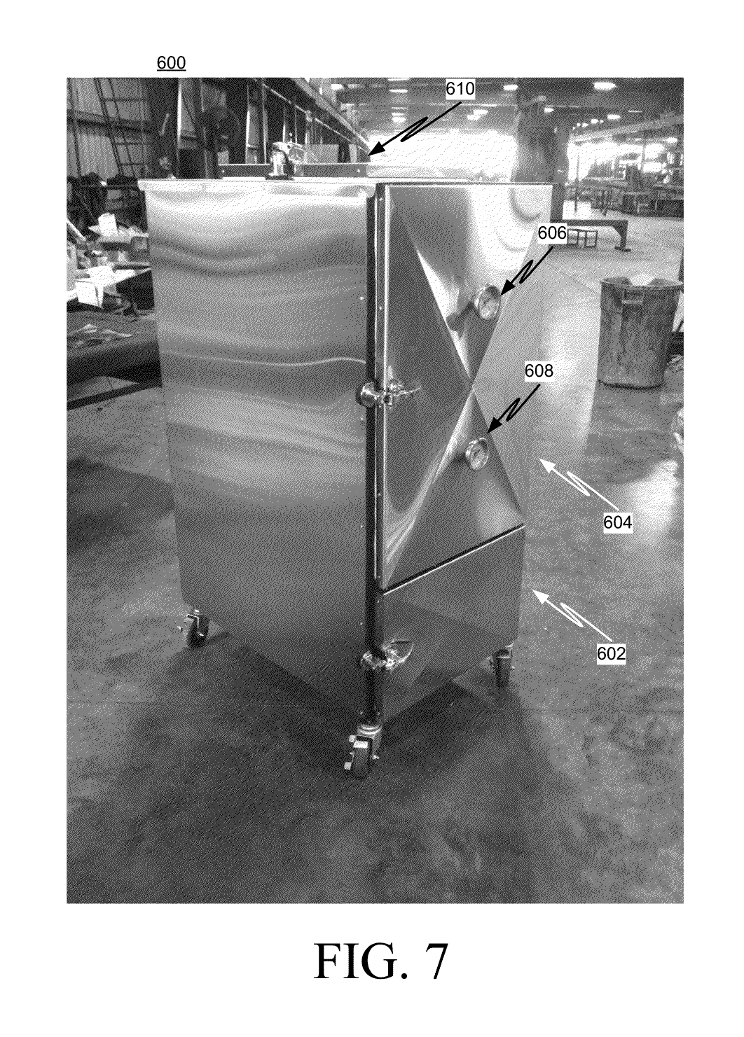

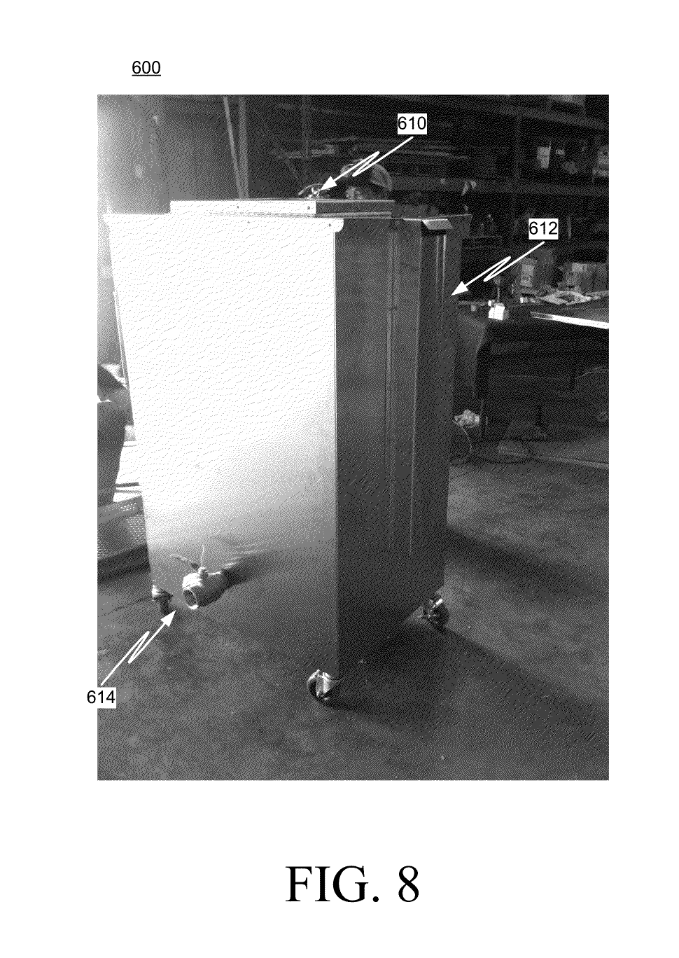

FIGS. 6-8 show photographs of an example smoker in accordance with at least one embodiment. The smoker 600 includes a firebox 602, a cooking chamber 604 and two temperature gauges 606 and 608. The smoker 600 also includes a top lid 610 configured to fit a catering/hotel pan. The smoker 600 also includes a chimney 612 and an air inlet valve 614.

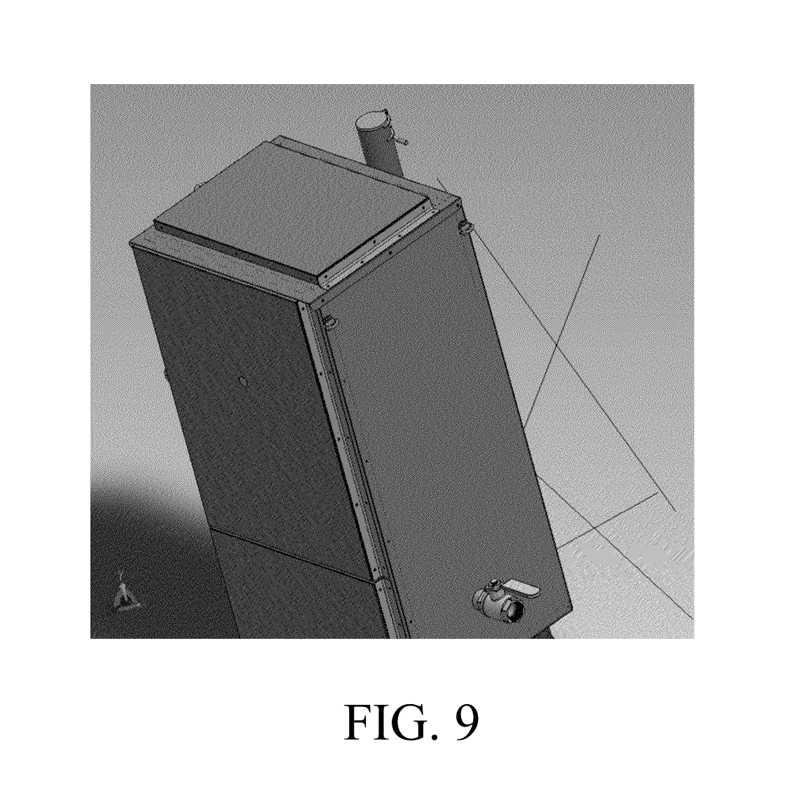

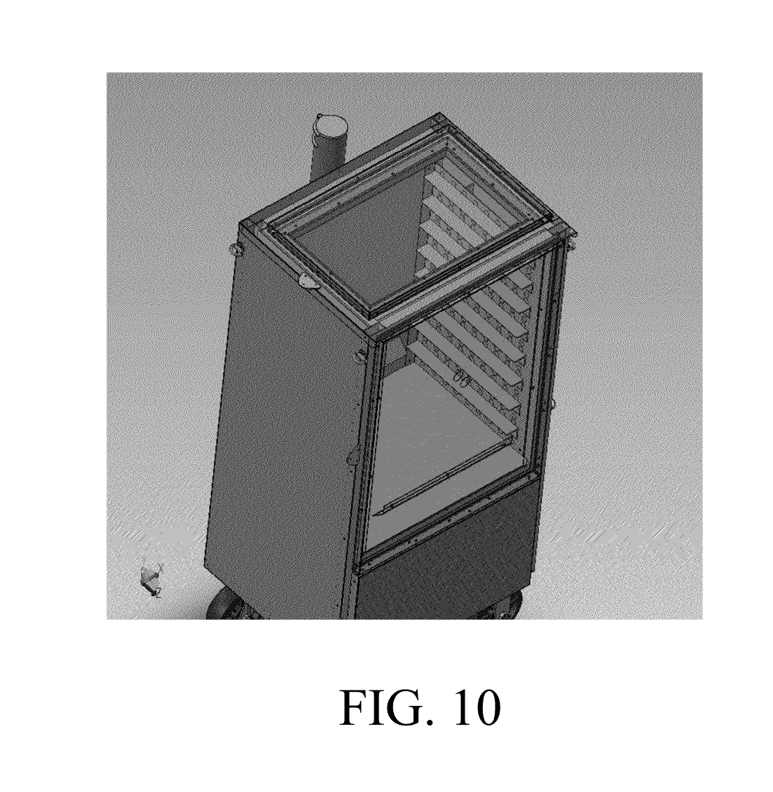

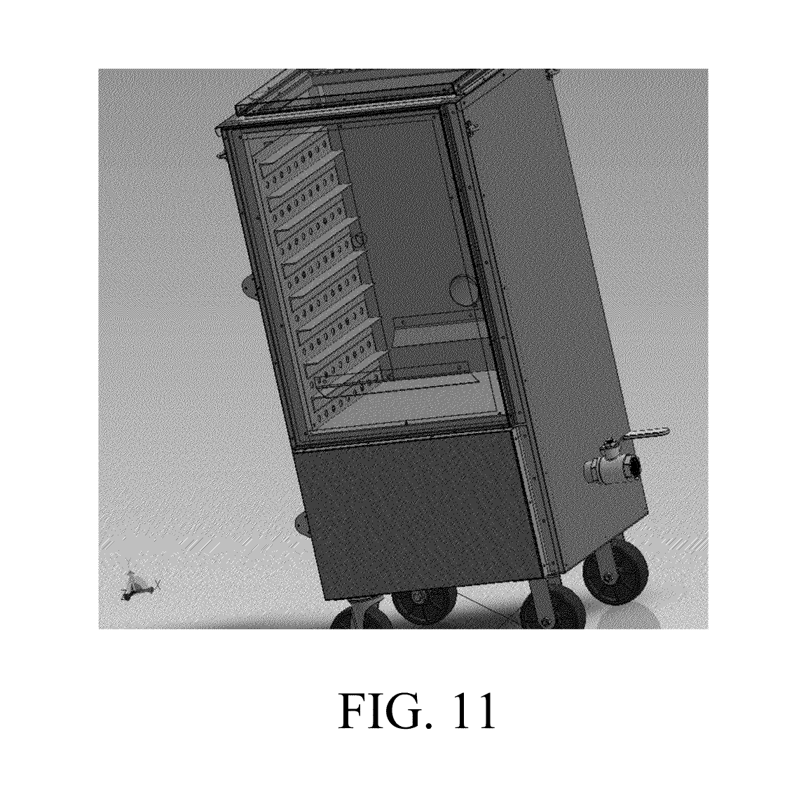

FIGS. 9-11 show an example smoker having “L” shaped rails disposed inside the cooking chamber, a pipe chimney, and generally circular openings in the inner walls disposed in groups that are interleaved vertically with the rails (e.g., openings in the sidewalls are formed in between the rails attached to the sidewalls).

Any dimensions shown in the drawings or mentioned herein are for illustration purposes only. It will be appreciated that an embodiment or implementation could include other suitable dimensions.

It is, therefore, apparent that there is provided, in accordance with the various embodiments disclosed herein, a smoker and grill apparatus and system.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A smoker comprising:
a cabinet housing a cooking chamber and a fire chamber, the cooking chamber defined by a cooking chamber top, a first portion of one or more outer sidewalls, a cooking chamber floor, and a first door, the fire chamber defined by a fire chamber top, a second portion of the one or more outer sidewalls, a fire chamber bottom and a second door;
an air inlet coupled to the fire chamber and configured to receive air from a source external to the cabinet and to convey the received air to the fire chamber;
one or more inner sidewalls disposed within the cooking chamber, the inner sidewalls being spaced a distance from the outer sidewalls so as to define a transfer space inside the cabinet, the fire chamber having one or more openings into the transfer space, the inner sidewalls having one or more openings formed at vertical intervals from a top of the cooking chamber to a bottom of the cooking chamber, the one or more openings configured to distribute heated air from the fire chamber to the cooking chamber via the transfer space; and
a chimney having a first opening in a lower area the cooking chamber and a second opening to the exterior of the cabinet, the chimney configured to exhaust air from the cooking chamber of the smoker.

2. The smoker of claim 1, wherein the cooking chamber top includes an opening having a hinged door, the opening being configured to receive a cooking pan when the door is in an open position.

3. The smoker of claim 1, wherein the cooking chamber top includes an opening having a hinged door, the opening being configured to receive a heat source when the door is in an open position.

4. The smoker of claim 1, wherein the inner sidewalls include rails configured to permit food cooking trays to be inserted into the smoker.

5. The smoker of claim 4, wherein the rails are formed to have an “L” shape in cross section.

6. The smoker of claim 4, wherein the rails are formed to have a “C” shape in cross section.

7. The smoker of claim 1, wherein the inner sidewalls include one or more top openings formed near the top of the cooking chamber, the one or more top openings configured to distribute heated air from the fire chamber to the cooking chamber via the transfer space.

8. The smoker of claim 1, wherein a portion of the one or more openings in the inner sidewalls near the top of the cooking chamber are smaller relative to a portion of the one or more openings in the inner sidewalls near the bottom of the cooking chamber.

9. The smoker of claim 1, wherein the one or more openings in the inner sidewalls are generally circular.

10. The smoker of claim 1, wherein the one or more openings in the inner sidewalls are generally linear.

11. The smoker of claim 1, wherein the one or more openings includes a plurality of openings the plurality of openings having one or more generally circular openings and one or more generally linear openings.

12. The smoker of claim 1, further comprising a first temperature gauge and a second temperature gauge, the first temperature gauge being disposed in an upper portion of the first, the second temperature gauge being disposed in a lower portion of the first door.

13. The smoker of claim 1, wherein the chimney includes a tube.

14. The smoker of claim 1, wherein the one or more openings are spaced at uneven vertical intervals.

15. The smoker of claim 1, further comprising a pellet fuel system coupled to the fire chamber and configured to provide pellet fuel to the fire chamber.

16. The smoker of claim 1, wherein the one or more openings are in groups spaced at vertical intervals corresponding to sets of rails disposed on an inside surface of the inner sidewalls, each set of rails being configured to receive a cooking pan.

17. The smoker of claim 1, further comprising a plurality of sets of rails disposed on an inside surface of the inner sidewalls, each set of rails being configured to receive a cooking pan.
